(19) United States
(12) Patent Application Publication
(10) Pub. No.: US 2018/0015714 A1
(43) Pub. Date: Jan. 18, 2018

(54) SCREEN PRINTING APPARATUS AND METHOD

(71) Applicant: ASM Assembly Systems Singapore Pte. Ltd., Singapore (SG)

(72) Inventor: Tom FALCON, Somerset (GB)

(21) Appl. No.: 15/606,570

(22) Filed: May 26, 2017

(30) Foreign Application Priority Data
Jul. 18, 2016 (GB) 1612444.8
Oct. 13, 2016 (CN) 201610892295.7

(51) Int. Cl. B41F 15/34

(52) U.S. Cl. CPC B41F 15/34

(57) ABSTRACT

A screen printing apparatus for screen printing onto a substrate comprises: a printing screen unit, with a printing screen and a frame for holding the printing screen in a substantially planar primary configuration; a support for the substrate; and a moveable print head for contacting and sweeping across a printing region of a first surface of the printing screen; an engagement structure mounted to contact a region of a surface of the printing screen which lies outside any part of the printing region which is drivable to move a portion of the printing screen in a direction orthogonal to the screen. Moving the screen away from the substrate improves separation between the printing screen and substrate. Moving the screen towards the substrate before printing can pre-tension the screen to reduce the tension which the print head has to overcome. Controlled movement of the screen towards and away from the substrate can reduce tension applied to the screen, and thus improve its working life.

### TECHNICAL FIELD

The present invention relates to a screen printing apparatus and a method for screen printing through a printing screen onto a substrate, typically an electronics substrate, such as a wafer for solar or fuel cells or a circuit board, using a print head, typically comprising a squeegee.

### BACKGROUND OF THE INVENTION

Various screen printing apparatus and methods already exist. However, the present inventor has recognized that these apparatus and methods suffer from a number of drawbacks.

Firstly, there is no direct control over separation of the printing screen and the substrate, known as peel-off, and this peel-off occurs faster at the edges of the image area than in the center of the image area, which has been noted to result in uneven print quality across the area of the printed substrate.

Secondly, the print head has to overcome the tension of the printing screen to apply pressure to the substrate, giving rise to an uneven print uniformity, because the resistance to travel of the print head is greater at the ends of the print head than in the center of the print head.

Thirdly, the life of the printing screen is reduced, because in every print cycle, some of the printing screen must be moved by a distance corresponding to the required print gap between the printing screen and the substrate, which progressively causes a loss of tension in the printing screen, leading to variation in print quality over the life of the printing screen as the tension decreases, and ultimately premature failure of the printing screen.

### SUMMARY OF THE INVENTION

It is an aim of the present invention to provide a screen printing apparatus and method which at least partially addresses one or more of the above-identified problems which have been recognized by the inventor.

In accordance with the present invention, it has been discovered that this aim may be achieved by providing a mechanism for moving at least a portion of the printing screen relative to its normal plane. By moving the screen away from the substrate after printing, improved separation between the printing screen and substrate can be achieved. By moving the screen towards the substrate before printing, the screen can be pre-tensioned so that the tension which the print head has to overcome is reduced. Finally, by controlled movement of the screen towards and away from the substrate, it is possible to reduce tension applied to the screen, and thus improve its working life.

In a preferred embodiment, the separation or peel-off of the printing screen from the substrate is controlled independently of the print speed and the print gap, thereby de-coupling the separation or peel-off from the print speed and the print gap, and so enabling optimisation of the peel-off in relation to the print speed. It is believed that peel-off has a greater effect on print quality than print speed, and, by independently controlling the peel-off, this aspect of the present invention enables the application of greater print speeds at the same separation or peel-off speed and yet maintains print quality, or enables the application of greater print speeds at a slower separation or peel-off speed and provides for improved print quality.

In another preferred embodiment the printing screen is brought into contact with the substrate before the print stroke, which enables the print head to be applied with lower pressure, insofar as the print head does not have to overcome the tension of the printing screen, and this pressure is more evenly distributed over the substrate. The application of a lower pressure provides for improved print quality across the substrate, and also provides for the print head and the printing screen to have a longer life.

In a further preferred embodiment the printing screen can be configured to have a neutral position from which the printing screen is moved before the print stroke in a first direction, typically downwards, by a distance less than the required print gap into contact with the substrate to be printed, and subsequently moved in a second direction opposite to the first direction, typically upwards, by a distance corresponding to the balance of the print gap, whereby the full print gap is established to enable separation and with a movement of the printing screen from the neutral position which is less than a distance corresponding to the required print gap. With this arrangement, the elastic stress on the printing screen is much reduced, so providing the printing screen with increased life.

In accordance with a first aspect of the present invention there is provided a screen printing apparatus for screen printing onto a substrate, comprising:

a printing screen unit, the printing screen unit comprising a printing screen and a frame for holding the printing screen in a substantially planar primary configuration, the printing screen including a plurality of apertures in an image area and through which a print medium is printed onto a substrate in use;

a support for supporting the substrate during printing; and

a print head which is moveable in a print direction substantially parallel to the plane of the printing screen, to print print medium through the printing screen onto the substrate in use during a print stroke, the print head contacting and sweeping across a printing region of a first surface of the printing screen during the print stroke;

an engagement structure mounted to contact in use a region of a surface of the printing screen which lies outside any part of the printing region and drivable to move at least a portion of the printing screen in a direction orthogonal to the plane of the screen.

The region of the surface of the printing screen which is contacted necessarily lies outside the printing region so as not to interfere with the movement of the print head. The contacted region may comprise an area on the same side of the printing screen as the print region but arranged outwardly thereof, or alternatively on the opposite surface of the printing screen, in which case it need not be arranged outwardly but could advantageously be centrally located, e.g. directly opposed to the printing region.

Advantageously, the apparatus may comprise at least one actuator to drive the engagement structure.

The engagement structure may comprise an engagement member drivable to move the printing screen portion in a direction away from the support, to separate the printing screen from the substrate subsequent to the print stroke in use. The engagement member may in use contact a second surface of the printing screen, oppositely arranged to the first surface, and is drivable to push the printing screen portion away from the support. The engagement member may comprise a roller.

The engagement member may be profiled to promote deflection of an intermediate region of the printing screen in relation to lateral edge regions thereof.

In some embodiments, the engagement member is attached to the printing screen, and is drivable to pull the printing screen portion away from the substrate.

The engagement structure may comprise an engagement member drivable to move the printing screen portion in a direction towards the substrate in use. The engagement member may in use contact the first surface of the printing screen, and is drivable to push the printing screen portion towards the substrate. Alternatively, the engagement member may be attached to the printing screen, and is drivable to pull the printing screen portion towards the substrate.

The engagement member may be drivable towards the substrate into a secondary position in which the distance of the printing screen is displaced from that of the primary configuration by a distance which is less than a distance (d) corresponding to a required print gap. The engagement member may also be drivable away from the substrate into a tertiary position in which the distance of the printing screen is displaced from that of the primary configuration by a distance which is less than a distance (d) corresponding to a required print gap.

The engagement structure may be drivable into a secondary configuration, and shaped so that, in the secondary configuration, the image area lies in a plane substantially parallel to the plane of the primary configuration.

The engagement structure may comprise first and second engagement members disposed on opposing sides of the image area and outwardly thereof, each engagement member extending along a respective side so as to have a length at least equal to the dimension of the image area along that side. In this case, the apparatus may comprise at least one additional engagement member disposed between the first and second engagement members and outward of the image area. Alternatively, the engagement structure may comprise an engagement member including an inner frame which at least partially surrounds the image area.

The or each engagement member may comprise a cam surface drivable in the print direction and the engagement structure comprises a cam element disposed to drive the cam surface orthogonally to the print direction. The cam element may be mounted to the print head.

The engagement structure may extend in a direction parallel to the print direction. In this case, the engagement structure may comprise a plurality of engagement members, sequentially disposed to extend in the direction parallel to the print direction. The or each engagement member may be independently drivable.

Alternatively, the engagement structure may comprise an engagement member which extends in the direction parallel to the print direction. The engagement member may be flexible.

Each end of the engagement member may be independently drivable. In accordance with a second aspect of the present invention there is provided a method for screen printing onto a substrate using screen printing apparatus, the screen printing apparatus comprising:

a printing screen unit comprising a printing screen and a frame for holding the printing screen in a substantially planar configuration, the printing screen including a plurality of apertures in an image area and through which a print medium is printed onto a substrate in use;

a support for supporting the substrate during printing; and

a print head which is moveable in a print direction substantially parallel to the is plane of the printing screen,

the method comprising the steps of:
i) performing a print stroke in which the print head contacts and sweeps across a printing region of a surface of the printing screen so as to print print medium through the printing screen onto the substrate, and
ii) moving at least a portion of the printing screen in a direction orthogonal to the plane of the screen, by engaging a region of a surface of the printing screen which lies outside any part of the printing region.

Step ii) may comprise moving the printing screen portion in a direction away from the substrate, to separate the printing screen from the substrate subsequent to performing the print stroke in step i). In this case, step ii) may comprise pushing the printing screen portion away from the substrate. Step ii) may further comprise deflecting an intermediate region of the printing screen in relation to lateral edge regions thereof.

Alternatively, step ii) may comprise pulling the printing screen portion away from the substrate.

Step ii) may comprise moving the printing screen portion in a direction towards the substrate, prior to performing the print stroke of step i). In this case, step ii) may comprise pushing the printing screen portion towards the substrate. Alternatively, step ii) may comprise pulling the printing screen portion towards the substrate.

The method may comprise the step of moving the printing screen portion towards the substrate into a secondary position in which the distance of the printing screen is displaced from that of the primary configuration by a distance which is less than a distance (d) corresponding to a required print gap, prior to performing step i). In this case, the method may further comprise the step of moving the printing screen portion away from the substrate into a tertiary position in which the distance of the printing screen is displaced from that of the primary configuration by a distance which is less than a distance (d) corresponding to a required print gap, subsequent to performing step i).

Step ii) may comprise moving the printing screen portion so that the image area lies in a plane substantially parallel to the plane of the primary configuration.

Step ii) may comprise moving the printing screen portion by providing the engagement structure with a cam element drivable in the print direction and disposed to drive a cam surface member in engagement with the printing screen orthogonally to the print direction. In this case, the cam element may be mounted to the print head.

Step ii) may comprise moving the printing screen portion independently of the print head.

### BRIEF DESCRIPTION OF THE DRAWINGS

Preferred embodiments of the present invention will now be described hereinbelow by way of example only with reference to the accompanying drawings, in which:

FIGS. 1(a) and (b) illustrate a screen printing apparatus in accordance with a first embodiment of the present invention;

FIG. 2 illustrates a screen printing apparatus in accordance with a second embodiment of the present invention;

FIGS. 3(a) and (b) illustrate a screen printing apparatus in accordance with a third embodiment of the present invention;

FIG. 4 illustrates a screen printing apparatus in accordance with a third embodiment of the present invention;

FIGS. 5(a) to (d) illustrate a screen printing apparatus in accordance with a fifth embodiment of the present invention;

FIG. 6 illustrates a screen printing apparatus in accordance with a sixth embodiment of the present invention;

FIG. 7 illustrates a screen printing apparatus in accordance with a seventh embodiment of the present invention;

FIG. 8 illustrates a screen printing apparatus in accordance with an eighth embodiment of the present invention;

FIGS. 9(a) to (d) illustrate a screen printing apparatus in accordance with a ninth embodiment of the present invention; and

FIGS. 10(a) and (b) illustrate a screen printing apparatus in accordance with a tenth embodiment of the present invention.

### DESCRIPTION OF PREFERRED EMBODIMENTS

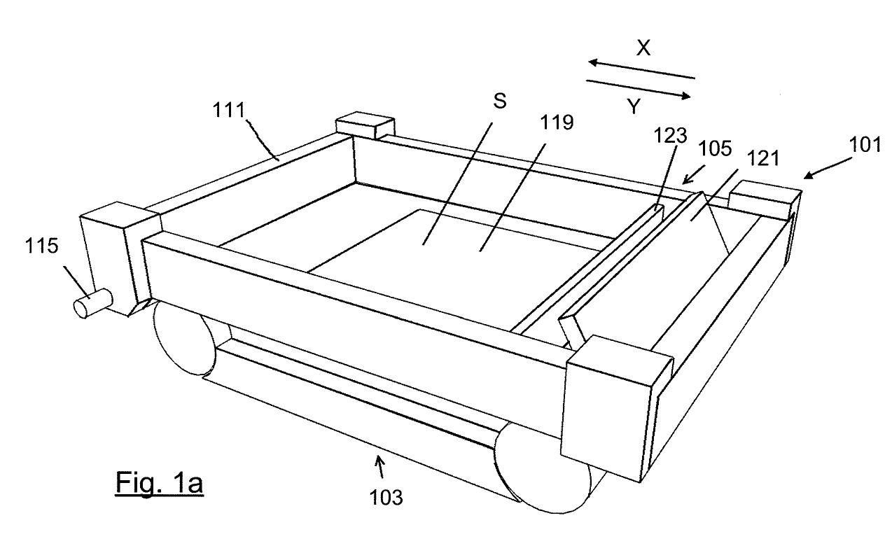

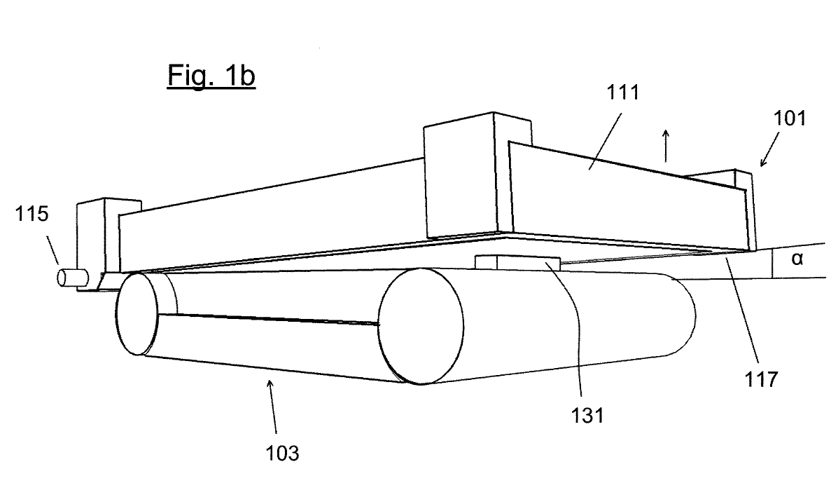

FIGS. 1(a) and (b) illustrate a screen printing apparatus in accordance with a first embodiment of the present invention.

The screen printing apparatus comprises a printing screen unit 101 through which a print medium is printed onto a substrate S, a support 103, in this embodiment in the form of a platen, here disposed beneath the printing screen unit 101, on which the substrate S is supported during printing, and a print head 105, which is operative in a print stroke to print print medium onto the substrate S.

The printing screen unit 101 comprises a frame 111, in this embodiment of rectangular shape, which is pivotable about a pivot 115 at one edge of the frame 111, and a printing screen 117 which is mounted under tension to the frame 111.

In this embodiment the printing screen unit 101 is pivoted about the pivot 115 by operation of an actuator (not illustrated), which acts to move the printing screen 117 away from the substrate S, in this embodiment upwardly in relation to the substrate S, thereby separating the printing screen 117 from the substrate S.

The printing screen 117 includes a pattern of apertures 119 in an image area, which pattern defines the pattern of deposits to be printed on the substrate S. The image area is therefore effectively defined by the outer extremities of the pattern.

In this embodiment the printing screen 117 comprises a mesh screen.

In this embodiment the print head 105 comprises a squeegee 121 which acts to force print medium into the apertures 119 in the printing screen 117 when the print head 105 is moved in a first, printing direction X, and a flood bar 123 which acts to flood the surface of the printing screen 117 with print medium when the print head 105 is moved in a second, flood direction Y, which is opposite to the printing direction X.

The screen printing apparatus further comprises an engagement structure including an engagement member 131 which is driven by an actuator (not illustrated), in this embodiment disposed within the support 103, and which acts to engage a central region of the under surface of the printing screen 117, which is intermediate the lateral edges of the printing screen 117, at a location upstream of the print apertures 119 in the printing direction X, and move the printing screen 117 away from the substrate S, in this embodiment upwardly in relation to the substrate S, thereby separating a central section of the printing screen 117 from the substrate S.

With this configuration, the engagement member 131 can be controlled independently of pivoting of the print screen unit 101, so as to provide that the central band of the printing screen 117 separates at the same speed as the lateral edges of the printing screen 117.

In this embodiment the engagement member 131 can be actuated simultaneously with or prior to pivoting of the printing screen unit 101.

In this embodiment the engagement member 131 is controlled independently of the print head 105, whereby the rate of separation or peel-off is controlled separately of the speed of the print head 105 and the print gap, and so enabling optimization of the print quality.

In this embodiment separation of the printing screen 117 from the substrate S is initiated during the print stroke of the print head 105.

In an alternative embodiment, separation of the printing screen 117 from the substrate S could be initiated subsequent to the print stroke of the print head 105.

In this embodiment the engagement member 131 comprises an elongate bar which extends across a width of the printing screen 117, here across substantially a center third of the width of the printing screen 117.

In one embodiment the engagement member 131 extends across a width of the printing screen 117 corresponding to the image area as defined by the pattern of apertures 119 in the printing screen 117.

In this embodiment the engagement member 131 extends across a width of the printing screen 117 from about a center third to about a center two-thirds of the width of the printing screen 117.

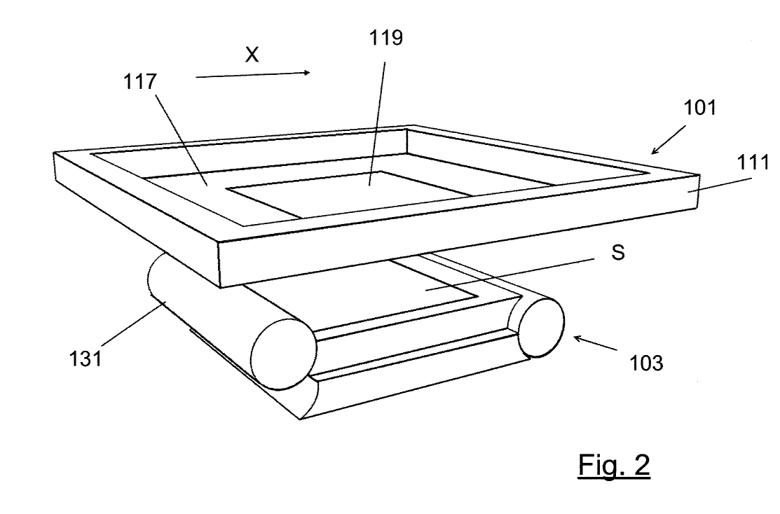

FIG. 2 illustrates a screen printing apparatus in accordance with a second embodiment of the present invention.

The screen printing apparatus of this embodiment is similar to the screen printing apparatus of the first-described embodiment, and thus, in order to avoid unnecessary duplication of description, only the differences will be described in detail, with like parts being designated by like reference signs.

The screen printing apparatus of this embodiment differs from that of the first-described embodiment in that the frame 111 has a fixed position during the print stroke and is not pivotable, and in that the engagement member 131 acts to deflect the printing screen 117, in this embodiment upwardly, in relation to the frame 111 and upstream of the image area in relation to the printing direction X, so as to separate or peel-off the printing screen 117 from the substrate S.

In this embodiment the engagement member 131 is provided by a roller on the support 103, which can be operative to transfer substrates S.

Operation is otherwise the same as for the first-described embodiment.

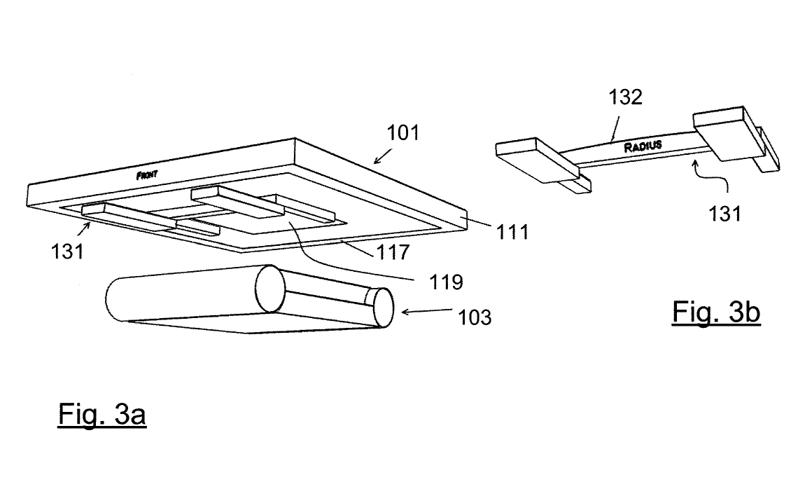

FIGS. 3(a) and (b) illustrate a screen printing apparatus in accordance with a third embodiment of the present invention.

The screen printing apparatus of this embodiment is similar to the screen printing apparatus of the first-described embodiment, and thus, in order to avoid unnecessary duplication of description, only the differences will be described in detail, with like parts being designated by like reference signs.

The screen printing apparatus of this embodiment differs from that of the first-described embodiment in that the frame 111 has a fixed position during the print stroke and is not pivotable, in that the engagement member 131 is profiled to promote deflection of a central band or region of the printing screen 117, in this embodiment upwardly, in relation to the frame 111, so as to separate or peel-off the printing screen 117 from the substrate S.

In this embodiment the engagement member 131 has a profiled upper surface 132, here an outwardly-projecting arcuate or curved surface which extends across a width of the printing screen 117.

With this arcuate or curved profile, on raising the engagement member 131 in relation to the printing screen 117, which is located flush or sub-flush to the printing screen 117 during the printing operation, separation of the central band or region of the printing screen 117 is promoted, so as to ensure a substantially uniform separation of the printing screen 117 from the substrate S across the width of the printing screen 117. Without this operation of the engagement member 131, the lateral edge regions of the printing screen 117 would separate ahead of the central region of the printing screen 117.

In one alternative embodiment the screen printing apparatus could comprise a pair of engagement members 131 which are disposed in spaced relation to opposite sides of the image area.

In one embodiment the engagement members 131 could be raised simultaneously or sequentially.

Operation is otherwise the same as for the first-described embodiment.

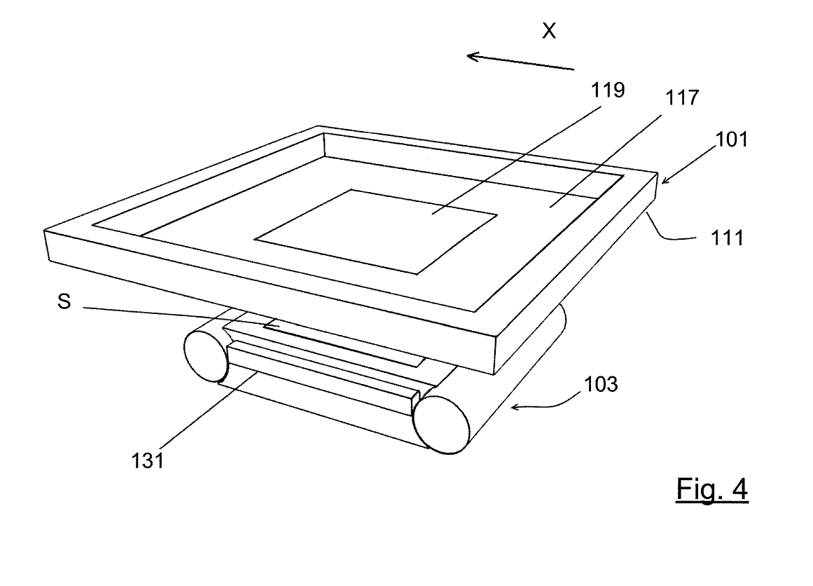

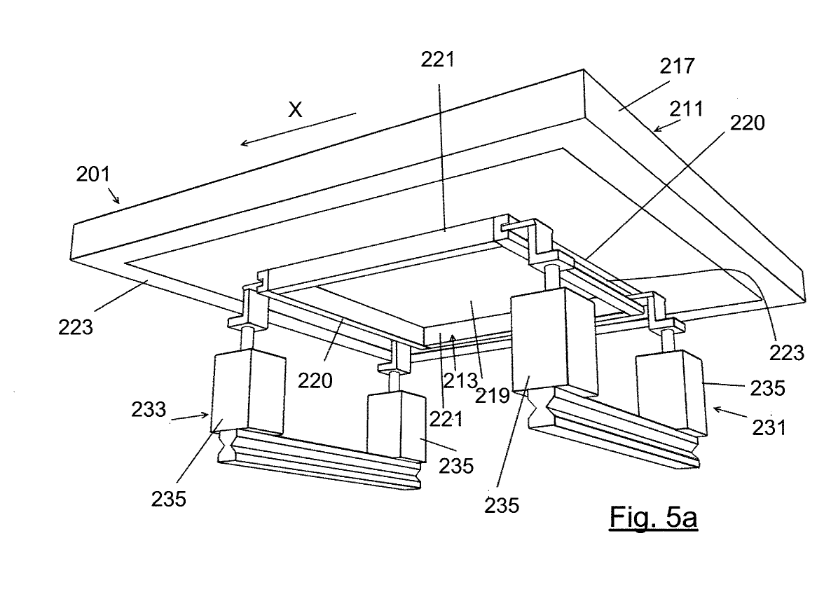

FIG. 4 illustrates a screen printing apparatus in accordance with a fourth embodiment of the present invention.

The screen printing apparatus of this embodiment is similar to the screen printing apparatus of the first-described embodiment, and thus, in order to avoid unnecessary duplication of description, only the differences will be described in detail, with like parts being designated by like reference signs.

The screen printing apparatus of this embodiment differs from that of the first-described embodiment in that the frame 111 has a fixed position during the print stroke and is not pivotable, in that the engagement member 131 acts to deflect the printing screen 117, in this embodiment upwardly, in relation to the frame 111 so as to separate or peel-off the printing screen 117 from the substrate S, and in that the engagement member 131 is provided to a lateral side of the image area as defined by the printing apertures 119. In one alternative embodiment the screen printing apparatus could comprise a pair of engagement members 131 which are disposed in spaced relation to opposite sides of the image area.

In one embodiment the engagement members 131 could be raised simultaneously or sequentially.

Operation is otherwise the same as for the first-described embodiment.

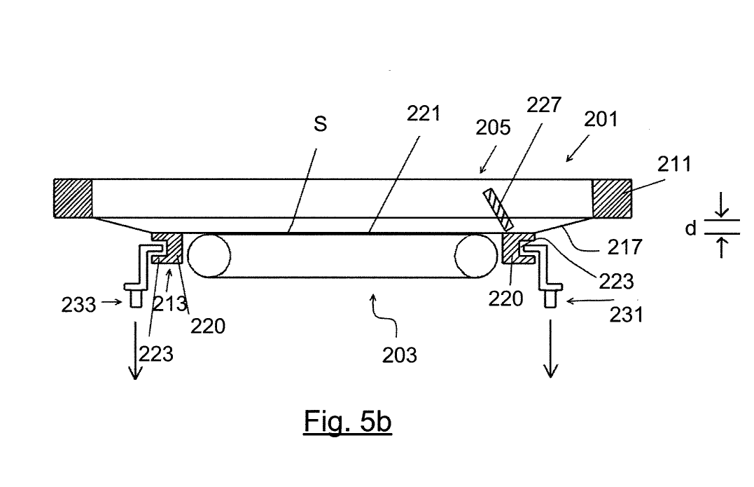

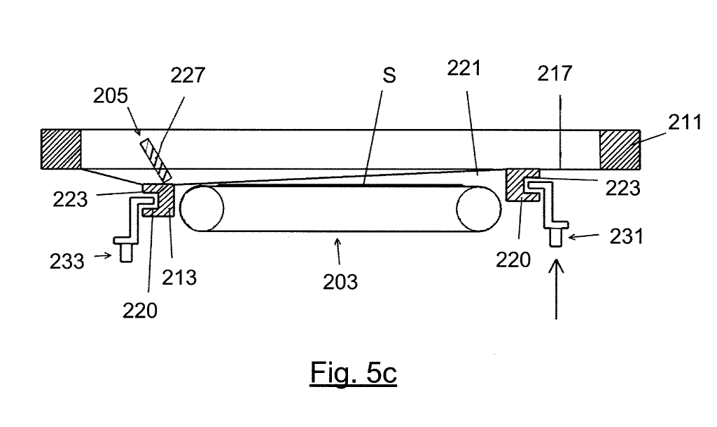

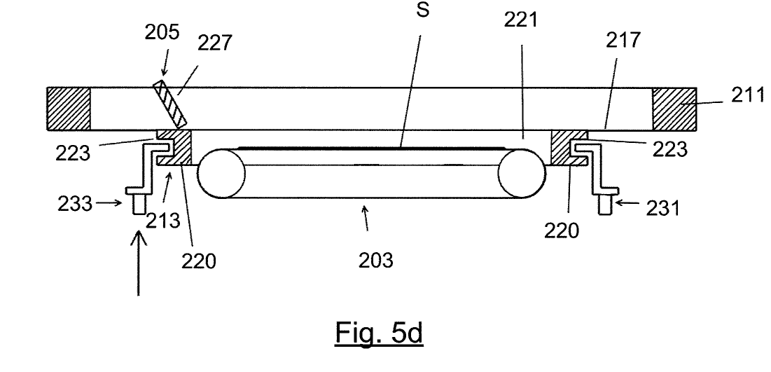

FIGS. 5(a) to (d) illustrate a screen printing apparatus in accordance with a fifth embodiment of the present invention.

The screen printing apparatus comprises a printing screen unit 201 through which a print medium is printed onto a substrate S, a support 203, in this embodiment in the form of a platen, on which the substrate S is supported during printing, in this embodiment beneath the printing screen unit 201, and a print head 205, which is operative in a print stroke to print print medium onto the substrate S.

The printing screen unit 201 comprises a first, outer frame 211, in this embodiment of rectangular shape, a second, inner frame 213, in this embodiment of rectangular shape, which is located within the outer frame 211, and a printing screen 217 which is mounted under tension to the outer and inner frames 211, 213.

In this embodiment the inner frame 213 is adhesively bonded to the printing screen 217.

In an alternative embodiment the inner frame 213 could be otherwise mechanically fixed to the printing screen 217, such as by clamping, for example, vacuum or magnetic clamping.

The printing screen 217 includes a pattern of apertures 219 which are located within the inner frame 213 and define the image area and the pattern of deposits to be printed on the substrate S.

In this embodiment the printing screen 217 comprises a mesh screen.

In this embodiment the inner frame 213 comprises a first pair of elongate engagement members 220 which are arranged in spaced relation to opposite ends in the printing direction X, here in parallel relation, and a second pair of elongate engagement members 221 which interconnect the respective ends of the first pair of elongate engagement members 220.

In this embodiment the first pair of elongate engagement members 220 each include an engagement feature 223, here in the form of a lateral groove in an outer face thereof, which are engaged by respective ones of first and second actuators 231, 233, as will be described in more detail hereinbelow.

In this embodiment the elongate engagement members 220, 221 comprise rigid members.

In an alternative embodiment the first pair of elongate engagement members 220 could comprise rigid members and the second pair of elongate engagement members 221 could comprise flexible members, with the rate and shape of the separation or peel-off being determined in accordance with the flexibility of the lateral elongate engagement members 221. In one embodiment the lateral elongate engagement members 221 can be configured so as to have non-uniform flexibility along the length thereof.

In this embodiment the print head 205 comprises a squeegee 227 which acts to force print medium into the apertures 219 in the printing screen 217 when the print head 205 is moved in the printing direction X.

The screen printing apparatus further comprises first and second actuators 231, 233 which are coupled to respective ones of the first pair of elongate engagement members 220, in this embodiment to the respective engagement features 223 thereof, and are operable independently of one another, whereby the rate of separation of the printing screen 217 and the substrate S can be controlled separately of the speed of the print head 205 and the print gap, so enabling optimisation of the print quality.

Operation of the screen printing apparatus will now be described with reference to FIGS. 5(b) to (d).

In a first step, as illustrated in FIG. 5(b), the inner frame 213 is lowered from a neutral position, as defined by the natural tension of the printing screen 217, in which the printing screen 217 is substantially parallel, to a lowered, printing position, in which the printing screen 217 within the inner fame 213 is spaced from the neutral position by a distance d corresponding to the required print gap.

Then, as illustrated in FIG. 5(c), the print head 205 is displaced to print print medium through the printing apertures 219 in the printing screen 217 onto the substrate S, and the first actuator 231 is operated to move, in this embodiment raise, the elongate engagement member 220 which is coupled thereto, being upstream of the image area in relation to the printing direction X, in this embodiment to return the printing screen 217 at the elongate engagement member 220 to the neutral position, moving the upstream elongate engagement member 220 through the distance d.

In this embodiment separation or peel-off of the printing screen 217 from the substrate S by operation of the first actuator 231 is initiated during the print stroke of the print head 205.

In an alternative embodiment separation or peel-off of the printing screen 217 from the substrate S could be initiated subsequent to the print stroke of the print head 205.

Next, as illustrated in FIG. 5(d), the second actuator 233 is operated to move, in this embodiment raise, the elongate engagement member 220 which is coupled thereto, being downstream of the image area in relation to the printing direction X, in this embodiment to return the printing screen 217 at the elongate engagement member 220 to the neutral position, moving the downstream elongate engagement member 220 through the distance d.

In this embodiment the first and second actuators 231, 233 each comprise first and second actuator elements 235 which are coupled to respective ends of the elongate engagement members 220.

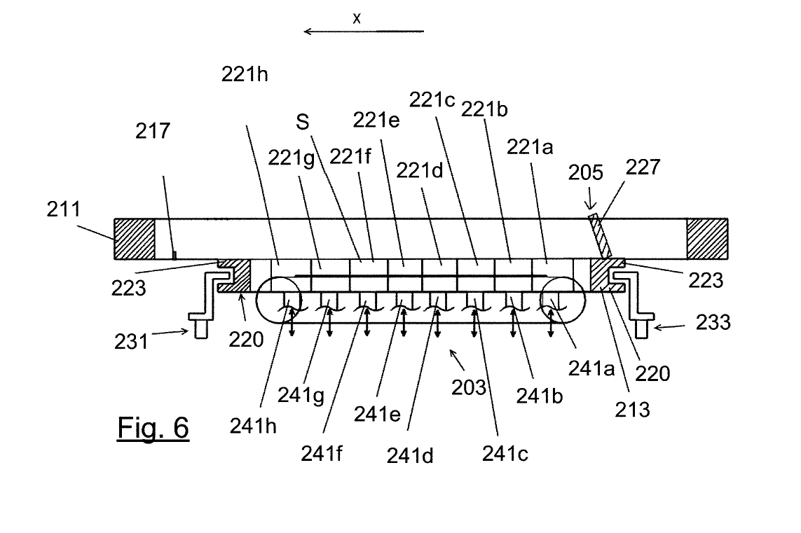

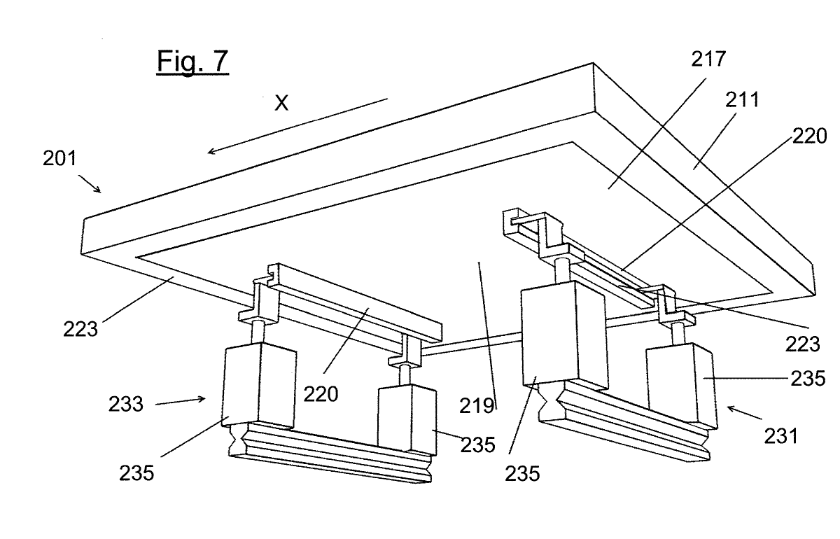

FIG. 6 illustrates a screen printing apparatus in accordance with a sixth embodiment of the present invention.

The screen printing apparatus of this embodiment is similar to the screen printing apparatus of the fifth-described embodiment, and thus, in order to avoid unnecessary duplication of description, only the differences will be described in detail, with like parts being identified by like reference signs.

The screen printing apparatus of this embodiment differs from that of the fifth-described embodiment in that the lateral elongate engagement members 221 each comprise a plurality of segments 221a-h, and in further comprising a plurality of actuators 241a-h which are coupled to the respective segments 221a-h of the elongate engagement members 221, such that the actuators 241a-h can be selectively controlled to control the advancing separation or peel-off of the printing screen 217 from the substrate S.

In one alternative embodiment the lateral elongate engagement members 221 could be flexible members, with the actuators 241a-h being coupled to adjacent sections thereof, in a similar manner to the respective segments 221a-h of the elongate engagement members 221.

Otherwise, operation is the same as for the fifth-described embodiment.

FIG. 7 illustrates a screen printing apparatus in accordance with a seventh embodiment of the present invention.

The screen printing apparatus of this embodiment is very similar to the screen printing apparatus of the fifth-described embodiment, and thus, in order to avoid unnecessary duplication of description, only the differences will be described in detail, with like parts being designated by like reference signs.

The screen printing apparatus of this embodiment differs from that of the fifth-described embodiment in that the inner frame 213 comprises instead only the first pair of elongate engagement members 220, with the second pair of elongate engagement members 221 being omitted.

Operation is the same as for the fifth-described embodiment.

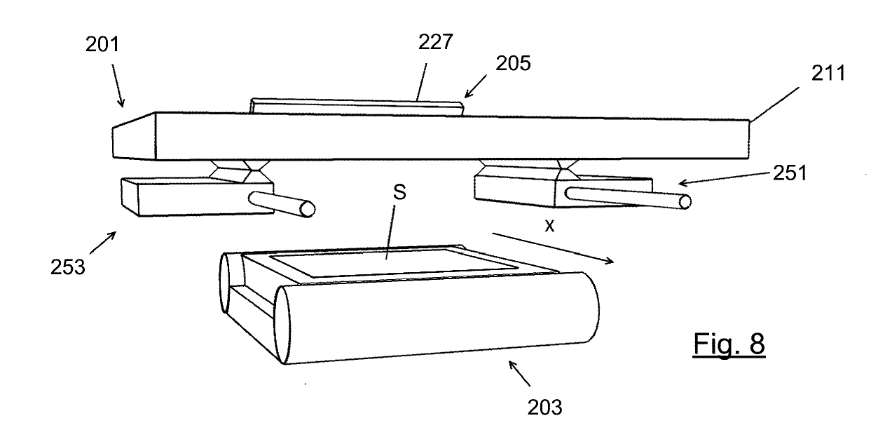

FIG. 8 illustrates a screen printing apparatus in accordance with an eighth embodiment of the present invention.

The screen printing apparatus of this embodiment is similar to the screen printing apparatus of the fifth-described embodiment, and thus, in order to avoid unnecessary duplication of description, only the differences will be described in detail, with like parts being designated by like reference signs.

The screen printing apparatus of this embodiment differs from that of the fifth-described embodiment in omitting the inner frame 213 and instead comprising first and second elongate clamping engagement members 251, 253 which are located in spaced relation outwardly of the image area as defined by the printing apertures 219, and operable in the manner of the first pair of elongate engagement members 220 in the fourth-described embodiment to provide for movement of the printing screen 219 therebetween in a first direction from the neutral position of the printing screen 217, in this embodiment lowering, by the distance d corresponding to the print gap, and in a second direction, opposite to the first direction, in this embodiment raising, by the distance d corresponding to the print gap to return the printing screen 217 to the neutral position, with the first and second clamping engagement members 251, 253 operated sequentially to control separation or peel-off of the printing screen 217 in relation to the substrate S.

In this embodiment the clamping engagement members 251, 253 are provided by vacuum bellows, which can be controlled to set the height of the printing screen 217 thereat by the extent of the vacuum, which acts against the tension in the printing screen 217.

In one embodiment the clamping engagement members 251, 253 are segmented along the length thereof, such that the pressure at the individual engagement segments is controllable independently, whereby progressive control of the separation or peel-off can be achieved along the printing direction X.

The screen printing apparatus of this embodiment further differs from the fifth-described embodiment in that the clamping engagement members 251, 253 are disposed to lateral sides of the image area in the printing direction X. In an alternative embodiment the clamping engagement members 251, 253 could be disposed to opposite ends of the image area in the printing direction X.

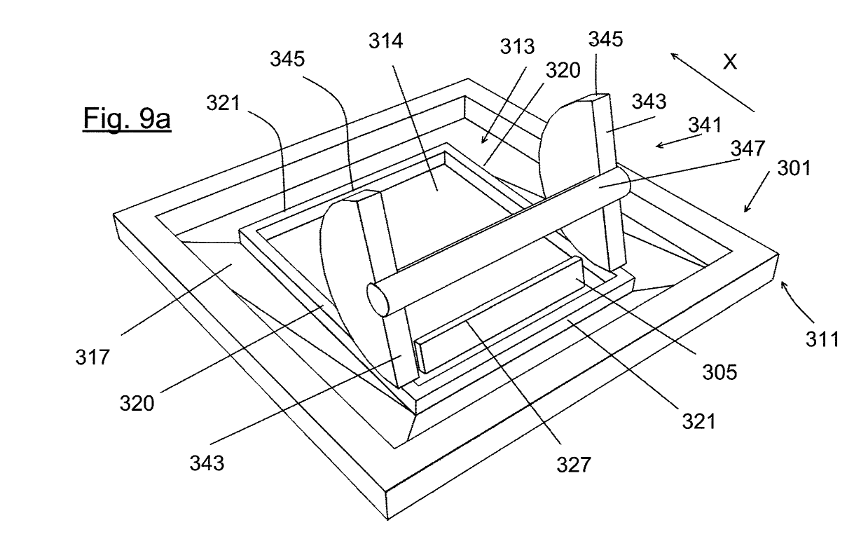

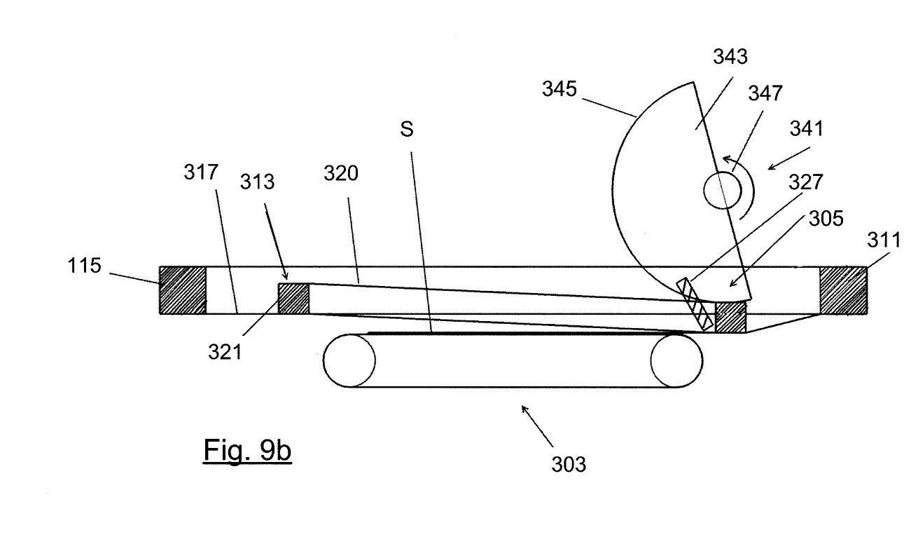

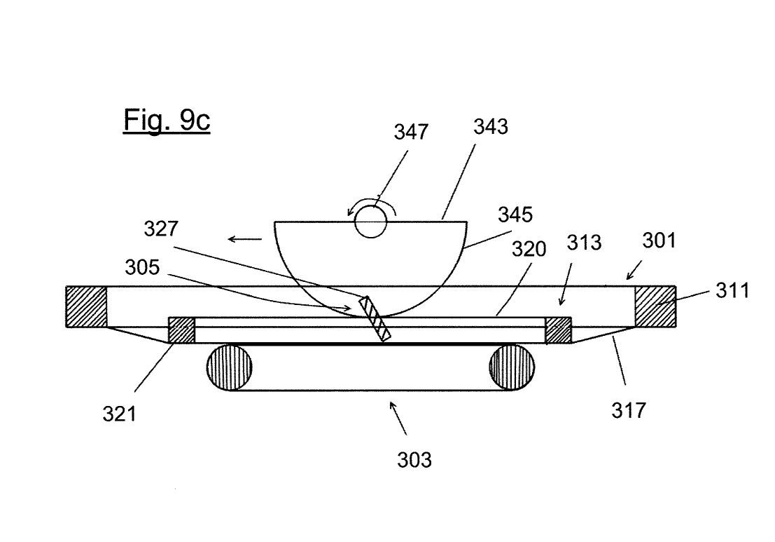

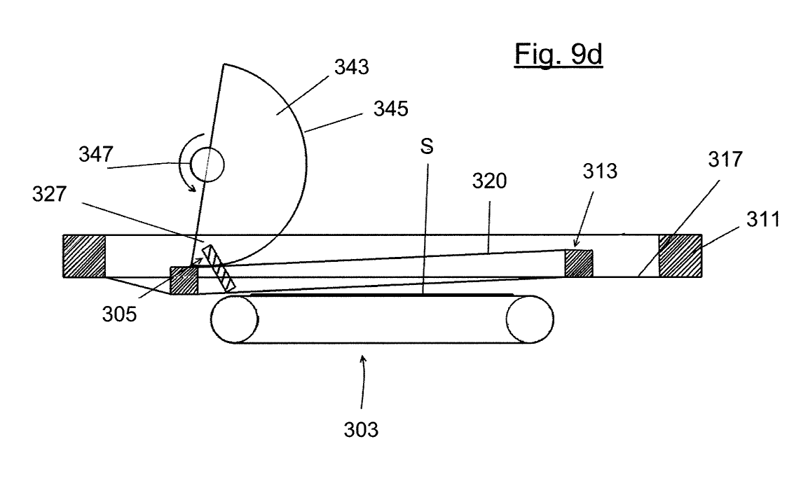

FIGS. 9(a) to (d) illustrate a screen printing apparatus in accordance with a ninth embodiment of the present invention.

The screen printing apparatus comprises a printing screen unit 301 through which a print medium is printed onto a substrate S, a support 303, in this embodiment in the form of a platen, on which the substrate S is supported during printing, in this embodiment beneath the printing screen unit 301, and a print head 305, which is operative in a print stroke to print print medium onto the substrate S.

The printing screen unit 301 comprises a first, outer frame 311, in this embodiment of rectangular shape, a second, inner frame 313, in this embodiment of rectangular shape, which is located within the outer frame 311, and a printing screen 317 which is mounted under tension to the outer and inner frames 311, 313.

In this embodiment the inner frame 313 is attached to a surface, here an upper surface, of the printing screen 317, which is opposite to the support 303.

In this embodiment the inner frame 313 is adhesively bonded to the printing screen 317.

In an alternative embodiment the inner frame 313 could be otherwise mechanically fixed to the printing screen 317, such as by clamping, for example, vacuum or magnetic clamping.

The printing screen 317 includes a pattern of apertures 319 which are located within the inner frame 313 and define the image area and the pattern of deposits to be printed on the substrate S.

In this embodiment the printing screen 317 comprises a mesh screen.

In this embodiment the inner frame 313 comprises a first pair of elongate engagement members 320 which are arranged in spaced relation to lateral sides of the image area in the printing direction X, here in parallel relation, and a second pair of elongate engagement members 321 which are arranged in spaced relation to opposite ends of the image area in the printing direction X and interconnect the respective ends of the first pair of elongate engagement members 320.

In this embodiment the elongate engagement members 320, 321 comprise rigid members.

In an alternative embodiment the first pair of elongate engagement members 320 could comprise flexible members, with the rate and shape of the separation or peel-off being determined in accordance with the flexibility of the lateral elongate members 320. In one embodiment the lateral elongate engagement members 320 can be configured so as to have non-uniform flexibility along the length thereof.

In one alternative embodiment the second pair of elongate engagement members 321 could be omitted.

In this embodiment the print head 305 comprises a squeegee 327 which acts to force print medium into the apertures 319 in the printing screen 317 when the print head 305 is moved in the printing direction X.

The screen printing apparatus further comprises cam element 341 which engages the first pair of lateral elongate engagement members 320 to displace the printing screen 317 from the neutral position thereof, in this embodiment downwardly, whereby the rate of separation or peel-off of the printing screen 317 from the substrate S can be controlled separately of the speed of the print head 305 and the print gap, so enabling optimization of the print quality.

In this embodiment the cam element 341 is coupled to the print head 305 so as to be moved in the printing direction X together with the print head 305.

In an alternative embodiment the cam element 341 could be coupled to a separate actuator which moves the cam element 341 in the printing direction X.

In this embodiment the cam element 341 comprises a pair of cam members 343 which engage respective ones of the lateral elongate engagement members 320.

In this embodiment the cam members 343 each have a cam surface 345 which bears on a cam surface of a respective one of the lateral elongate engagement members 320, and, with movement of the cam element 341 in the printing direction X, the cam members 343 are rotated, such that a length of the cam surface 345 bears on a length of the respective lateral elongate engagement member 320.

In this embodiment the cam surface 345 is an arcuate surface.

In this embodiment the cam members 343 are interconnected, here by a shaft 347, such as to be moved in unison.

Operation of the screen printing apparatus will now be described with reference to FIGS. 9(b) to (d).

In a first step, as illustrated in FIG. 9(b), the cam element 341 is lowered in relation to the printing screen 317, and the cam surfaces 345 of the cam members 343 engage respective ones of the lateral elongate engagement members 320 at one, the upstream end thereof in the printing direction X, whereby the inner frame 313 is lowered at the one, upstream edge thereof from a neutral position, as defined by the natural tension of the printing screen 317, by a distance d corresponding to the required print gap.

Then, as illustrated in FIG. 9(c), the print head 305 is moved in the printing direction X to print print medium through the printing apertures 319 in the printing screen 317 onto the substrate S, and the cam element 341 is moved simultaneously in the printing direction X to cause the inner frame 313 to be lowered from the neutral position forwardly of the print head 305 by a distance d corresponding to the required print gap, whereby the image area of the printing screen 317 is in in contact with the substrate S during application of the squeegee 327.

As illustrated in FIG. 9(d), at the end of the print stroke, the cam surfaces 345 of the cam members 343 engage respective ones of the lateral elongate engagement members 320 at the other, downstream end thereof in the printing direction X, whereby the inner frame 313 is lowered at the other, downstream edge thereof from the neutral position by the distance d corresponding to the required print gap, and the one, upstream edge of the inner frame 313 is returned substantially to the neutral position under the action of the tension in the printing screen 317.

Following the print stroke, the cam element 341 is raised in relation to the printing screen 317, and the other, downstream edge of the inner frame 313 is returned substantially to the neutral position under the action of the tension in the printing screen 317.

In one alternative embodiment the cam element 341 could be provided as a roller or slide which engages with and is moved along a length of the lateral elongate engagement members 320, causing the inner frame 313 to be deflected downwardly as the roller or slide passes thereover.

In another alternative embodiment the cam element 341 could be provided as one of a track or follower which engages with counterpart one of a track or follower on the lateral elongate engagement members 320, causing the inner frame 313 to be deflected downwardly as the track or follower passes along a length of the lateral elongate engagement members 320.

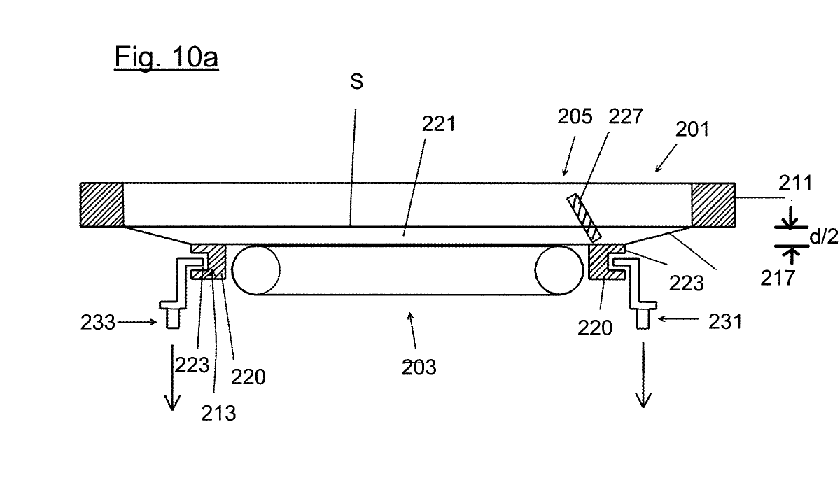

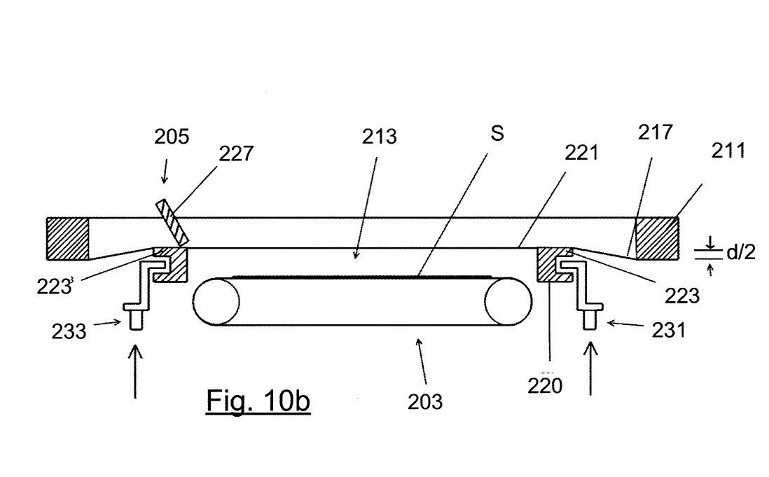

FIGS. 10(a) to (c) illustrate a screen printing apparatus in accordance with a tenth embodiment of the present invention.

The screen printing apparatus of this embodiment is similar to the screen printing apparatus of the fifth-described embodiment, and thus, in order to avoid unnecessary duplication of description, only the differences will be described in detail, with like parts being identified by like reference signs.

The screen printing apparatus of this embodiment differs from that of the fifth-described embodiment in the mode of operation.

In this embodiment the actuators 231, 233 are controlled such that the printing screen 217 is moved in any one direction through a distance which is less than a distance d corresponding to the required print gap, in this embodiment by a distance d/2 which is not greater than half of the required print gap.

First, print medium is applied, e.g. flooded, to the printing screen 217 while it is in a neutral position, as defined by the natural tension of the printing screen 217.

Next, as illustrated in FIG. 10(a), the actuators 231, 233 are controlled to move the printing screen 217 in a first direction away from the neutral position (primary configuration) of the printing screen 217, as defined by the natural tension of the printing screen 217 held by frame 211, in this embodiment downwardly, into a secondary configuration in which a portion of the printing screen 217 has been displaced by a distance d/2, such that the image area of the printing screen 217 is brought into contact with the substrate S.

Then, then print head 205 is moved in a print stroke to print print medium through the apertures 219 in the printing screen 217 and onto the substrate S. Subsequently, as illustrated in FIG. 10(b), the actuators 231, 233 are controlled to move the printing screen 217 in a second direction, opposite to the first direction, towards and through the neutral position of the printing screen 217, in this embodiment upwardly, by a distance d, into a tertiary configuration such that the image area of the printing screen 217 is moved a distance d/2 to the opposite side of the neutral position of the printing screen 217.

With this mode of operation, the printing screen 217 is moved from the neutral position by a distance which corresponds to a half of the required print gap, which advantageously provides that the printing screen 217 is put under significantly less stress as compared to the mode of operation in which the printing screen is moved from the neutral position in a single direction by a distance which corresponds to the required print gap.

In alternative embodiments the actuators 231, 233 could be controlled such that the printing screen 217 is moved from the neutral position in either direction by a distance kd (where k<1), which is less than the print gap.

In another alternative embodiment the actuators 231, 233 could be controlled such that the printing screen 217 is moved from the neutral position in a first direction by a distance kd and in the second opposite direction by a distance (1−k)d/k (where k is less than 1 and d is the print gap).

It should be understood that this concept of moving the frame away from the plane of the printing screen by an amount<d can be achieved in various ways, in particular by using apparatus similar to that shown in any of FIGS. 1-8.

Finally, it will be understood that the present invention has been described in its preferred embodiments and can be modified in many different ways without departing from the scope of the invention as defined by the appended claims.

1. A screen printing apparatus for screen printing onto a substrate, comprising:
a printing screen unit, the printing screen unit comprising a printing screen and a frame for holding the printing screen in a substantially planar primary configuration, the printing screen including a plurality of apertures in an image area and through which a print medium is printed onto a substrate in use;
a support for supporting the substrate during printing; and
a print head which is moveable in a print direction substantially parallel to the plane of the printing screen, to print print medium through the printing screen onto the substrate in use during a print stroke, the print head contacting and sweeping across a printing region of a first surface of the printing screen during the print stroke;
an engagement structure mounted to contact in use a region of a surface of the printing screen which lies outside any part of the printing region and drivable to move at least a portion of the printing screen in a direction orthogonal to the plane of the screen.

2. Apparatus according to claim 1, comprising at least one actuator to drive the engagement structure.

3. Apparatus according to claim 1, wherein the engagement structure comprises an engagement member drivable to move the printing screen portion in a direction away from the support, to separate the printing screen from the substrate subsequent to the print stroke in use.

4. Apparatus according to claim 3, wherein the engagement member in use contacts a second surface of the printing screen, oppositely arranged to the first surface, and is drivable to push the printing screen portion away from the support.

5. Apparatus according to claim 4, wherein the engagement member is profiled to promote deflection of an intermediate region of the printing screen in relation to lateral edge regions thereof.

6. Apparatus according to claim 3, wherein the engagement member is attached to the printing screen, and is drivable to pull the printing screen portion away from the substrate.

7. Apparatus according to claim 1, wherein the engagement structure comprises an engagement member drivable to move the printing screen portion in a direction towards the substrate in use.

8. Apparatus according to claim 7, wherein the engagement member in use contacts the first surface of the printing screen, and is drivable to push the printing screen portion towards the substrate.

9. Apparatus according to claim 7, wherein the engagement member is attached to the printing screen, and is drivable to pull the printing screen portion towards the substrate.

10. Apparatus according to claim 7, wherein the engagement member is drivable towards the substrate into a secondary position in which the distance of the printing screen is displaced from that of the primary configuration by a distance which is less than a distance (d) corresponding to a required print gap.

11. Apparatus according to claim 10, wherein the engagement member is drivable away from the substrate into a tertiary position in which the distance of the printing screen is displaced from that of the primary configuration by a distance which is less than a distance (d) corresponding to a required print gap.

12. Apparatus according to claim 7, wherein the engagement structure is drivable into a secondary configuration, and shaped so that, in the secondary configuration, the image area lies in a plane substantially parallel to the plane of the primary configuration.

13. Apparatus according to claim 1, wherein the engagement structure comprises first and second engagement members disposed on opposing sides of the image area and outwardly thereof, each engagement member extending along a respective side so as to have a length at least equal to the dimension of the image area along that side.

14. Apparatus according to claim 7, wherein the or each engagement member comprises a cam surface drivable in the print direction and the engagement structure comprises a cam element disposed to drive the cam surface orthogonally to the print direction.

15. Apparatus according to claim 1, wherein the engagement structure extends in a direction parallel to the print direction and the engagement structure comprises a plurality of engagement members, sequentially disposed to extend in the direction parallel to the print direction.

16. Apparatus according to claim 15, wherein the or each engagement member is independently drivable.

17. Apparatus according to claim 11, wherein the engagement structure extends in a direction parallel to the print direction and the engagement structure is flexible.

18. Apparatus according to claim 17, wherein each end of the engagement structure is independently drivable.

19. A method for screen printing onto a substrate using screen printing apparatus, the screen printing apparatus comprising:
a printing screen unit comprising a printing screen and a frame for holding the printing screen in a substantially planar configuration, the printing screen including a plurality of apertures in an image area and through which a print medium is printed onto a substrate in use;
a support for supporting the substrate during printing; and
a print head which is moveable in a print direction substantially parallel to the plane of the printing screen,
the method comprising the steps of:
i) performing a print stroke in which the print head contacts and sweeps across a printing region of a surface of the printing screen so as to print print medium through the printing screen onto the substrate, and
ii) moving at least a portion of the printing screen in a direction orthogonal to the plane of the screen, by engaging a region of a surface of the printing screen which lies outside any part of the printing region.

20. A method according to claim 19, wherein step ii) comprises moving the printing screen portion in a direction away from the substrate, to separate the printing screen from the substrate subsequent to performing the print stroke in step i).

21. A method according to claim 19, wherein step ii) comprises moving the printing screen portion in a direction towards the substrate, prior to performing the print stroke of step i).

22. A method according to claim 21, comprising the step of moving the printing screen portion towards the substrate into a secondary position in which the distance of the printing screen is displaced from that of the primary configuration by a distance which is less than a distance (d) corresponding to a required print gap, prior to performing step i).

23. A method according to claim 22, comprising the step of moving the printing screen portion away from the substrate into a tertiary position in which the distance of the printing screen is displaced from that of the primary configuration by a distance which is less than a distance (d) corresponding to a required print gap, subsequent to performing step i).
